(19) United States
(12) Patent Application Publication
(10) Pub. No.: US 2022/0090645 A1
(43) Pub. Date: Mar. 24, 2022

(54) Apparatus for Stabilizing Movements of Two Elements That are Movable Relative to One Another

(71) Applicant: BETTERGUARDS TECHNOLOGY GmbH, Berlin (DE)

(72) Inventors: Vinzenz BICHLER, Berlin (DE); Timo STUMPER, Berlin (DE)

(73) Assignee: BETTERGUARDS TECHNOLOGY GmbH, BERLIN (DE)

(21) Appl. No.: 17/311,579

(22) PCT Filed: Dec. 5, 2019
(86) PCT No.: PCT/EP2019/083860

§ 371 Date: Jun. 7, 2021

(30) Foreign Application Priority Data
Dec. 7, 2018 (DE) 10 2018 131 463.9

(51) Int. Cl. F16F 9/54; F16F 9/19

(52) U.S. Cl. CPC F16F 9/54; F16F 9/19; F16F 2222/12; F16F 2226/04; F16F 2228/004; F16F 2230/0005; F16F 2232/08

(57) ABSTRACT

An apparatus for stabilizing movements of two elements of a body joint and/or of a piece of sports equipment that are movable relative to one another, the apparatus comprising: a receptacle fixable to a first element, the receptacle being filled with a filling medium and the receptacle comprising a receiving opening, and an interaction element, which is fixable to a second element and is displaceable received at least in part in the receptacle and extends through the receiving opening, the part of the interaction element that is situated in the receptacle being able to interact with the filling medium. The receptacle comprises a first attachment element for transmitting force between the receptacle and the first body, and the interaction body comprising a second attachment element for transmitting force between the interaction body and the second body, the first attachment element comprising at least one protrusion, which extends from a longitudinal axis of the apparatus, in order provide an attachment surface for fixing the first body.

### CROSS REFERENCE TO RELATED APPLICATIONS

This application is a national stage U.S. patent application of International Application No. PCT/EP2019/083860, filed on Dec. 5, 2019, and claims foreign priority to German Patent Application No. DE 10 2018 131 463, filed on Dec. 7, 2018, the entirety of each of which is incorporated herein by reference.

### TECHNICAL FIELD

The present disclosure relates to a device for stabilizing movements of two bodies of a body joint and/or of an item of sports equipment that can be moved relative to one another.

### DESCRIPTION OF THE RELATED ART

The practice of stabilizing body joints, muscles and tendons by means of devices which allow an adaptive movement restriction is known. The provision of sports equipment which may be exposed to backward movements with adaptive movement restricting devices is also known.

The adaptive behavior of such devices is achieved, inter alia, by virtue of two bodies moving relative to one another, with a filling medium being located between the bodies. In this respect, a body of the device may form a receptacle which is filled with the filling medium. The other body may form an interaction body, which is arranged movably in the receptacle. The filling medium can flow in the region between the receptacle and the interaction body when the two bodies move relative to one another. The flow velocity of the filling medium significantly depends on the cross-sectional area perpendicular to a relative displacement direction of the receptacle and of the interaction body. This cross-sectional area, which is available for the flow of the filling medium, is also referred to as the hydraulic diameter and is for the reactive behavior of the device in the event of an external action of force. In this way, the selection of the hydraulic diameter makes it possible to establish the resistance with which the device counteracts external forces. The devices can be fixed between two locations on the body of a user or two elements of an item of sports equipment that can be moved relative to one another.

If physiological forces, that is to say forces which are not critical for the body part or component correspondingly to be stabilized, are introduced into the device via the two locations on the body of the user, a corresponding relative movement of the receptacle and of the interaction body and thus a movement of the body part to be stabilized is permitted in accordance with the hydraulic diameter in the device.

If, by contrast, unphysiological forces, that is to say forces which are critical for the body part or component correspondingly to be stabilized, are introduced into the device, a relative movement between the interaction body and the receptacle is only possible with a very high expenditure of force on account of the hydraulic diameter.

When force is transferred between two points on the body, the force flow runs between the interaction body, the operative medium and the receptacle. Correspondingly, the receptacle must be configured to provide an interface for the transfer of force to a first body which is not part of the device. In turn, the interaction body must provide an interface for the transfer of force to a second body which is not part of the device and can be moved relatively with respect to the first body which is not part of the device.

A corresponding device, which is arranged between two body parts or two components of an item of sports equipment, i.e. bodies which are not part of the device, must withstand high degrees of loading to effectively control and stabilize movements of the two body parts relative to one another.

Such a device is known from U.S. Pat. No. 5,712,011, for example. U.S. Pat. No. 5,712,011 discloses a device with two bodies which can be moved relative to one another. A first body comprises a receptacle, which is filled with a fluid. The second body extends at least partially into the receptacle of the first body and is configured to interact with the fluid. The interaction makes it possible to damp relative movements between the first and the second body. The first body and the second body have force connection points, as interfaces to two elements which can be moved relative to one another, between which the device is used.

The connection points in this case are each arranged at the oppositely situated outermost points of the first body and of the second body. This produces a force flow between the connection point of the first body, the receptacle of the first body, the fluid, that part of the second body which is arranged in the receptacle of the first body, and finally the connection point of the second body. This results in the disadvantage that the entire receptacle body is subjected to load in the event of an applied force. Correspondingly, there are high strength requirements for the entire structure of the receptacle, which ultimately acts as a limiting factor and limits the range of applications of the device.

In other solutions known from the related art, the receptacle is closed off by a closure and/or a seal on the side at which an interaction body penetrates into the receptacle. In this case, the interaction body extends through the closure or the seal. If the connection point for the transfer of force of the receptacle is then selected in such a way that the force is conducted primarily by way of the receptacle wall, the link between the receptacle and the closure or the seal can be adversely affected in the event of loading and there is the risk that the closure is pressed out of the receptacle.

Correspondingly, there is a need for a connection solution which relieves the receptacle of the device of load in the event of loading.

### SUMMARY OF THE DISCLOSURE

The present disclosure is provides a device for stabilizing movements of two bodies which can be moved relative to one another.

Disclosed is a device for stabilizing movements of two bodies of a body joint and/or of an item of sports equipment that can be moved relative to one another, said device comprising: a receptacle which can be fixed to a first body, the receptacle being filled with a filling medium and the receptacle comprising a receiving opening, and an interaction body which can be fixed to a second body, is displacably received at least partially in the receptacle and extends through the receiving opening, it being possible for that part of the interaction body which is located in the receptacle to interact with the filling medium.

The receptacle comprises a first connection element for the transfer of force between the receptacle and the first body, and the interaction body comprises a second connection element for the transfer of force between the interaction body and the second body. According to the disclosure, the first connection element is arranged in the region of the receiving opening for the transfer of force between the receptacle and the first body.

An arrangement of the first connection element for the transfer of force in the region of the receiving opening makes it possible to realize force paths in the event of loading that ensure that the receptacle withstands even high loads and no undesired leakage of the receptacle occurs in the region of the on assumption opening. In addition, the remainder of the receptacle may have a comparatively thin-walled design, since forces do not act primarily on the peripheral walls of the receptacle in the event of loading.

In an embodiment, the first connection element is inserted in the receiving opening or placed on the receiving opening. This arrangement has the result that the first connection element counteracts a detachment of the first connection element from the receptacle in a self-locking manner in the event of loading of the device. Forces acting on the device in the event of loading have the result that the first connection element is pressed against or into the receptacle.

In an implementation, the first connection element at least partially closes off a receiving space of the receptacle with respect to the surroundings. In this way, the first connection element is additionally provided with a closure function. The first connection element consequently forms a closure for the receptacle and prevents the operative medium arranged in the receptacle from being discharged into the surroundings. In this respect, the connection element may partially act as a lid or plug.

In an implementation, the first connection element extends substantially perpendicularly from a longitudinal axis of the device in order to provide a connection surface for fixing to the first body. This makes it possible to provide a sufficiently large connection surface which serves as an interface for the transfer of force between the receptacle and the first body. In addition, when the receptacle has a correspondingly narrow configuration, it is possible to substantially restrict the device to a two-dimensional orientation. This considerably facilitates the integration of the device in items of clothing or sports equipment, for example.

In an embodiment, the first connection element can transfer forces of at least 2000 N between the receptacle and the first body. As a result, the device is suitable for use in stabilizing body joints of humans and animals as well as parts of sporting equipment that can be moved relative to one another.

In an implementation, the first connection element is formed in one piece with the receptacle. As a result, the reliability of the interaction of the first connection element and the receptacle can be further increased.

In another embodiment, the first connection element is connected to the receptacle in an adhesively bonded, welded, screwed, interference-fitting and/or form-fitting manner. This makes it possible to manufacture the first connection element and the receptacle from different materials. Preferably, the first connection element is manufactured from plastic and the receptacle from metal, such as aluminum. The selection of the materials for the first connection element and the receptacle can thus be adapted to the respective field of application of the device.

In a configuration in that the first connection element is a connection flange which provides a connection for fixing the device to a first body which is not part of the device.

In an embodiment, the first connection element comprises at least one wing body, which extends substantially perpendicularly from a longitudinal axis of the device in order to form a planar connection for tapes, dressings, bandages, and the like. The at least one wing body increases the surface area of the first connection element and, as a result, provides an additional surface which can be adhesively bonded or enclosed in a bandage in order to fasten the first connection element to a first body which is not part of the device.

In an implementation, the first connection element comprises a first connection portion, which extends substantially perpendicularly from a longitudinal axis of the device, and comprises at least one support arm on at least one outer end of the first connection portion, the support arm extending in part parallel to the receptacle, and an outer end of the support arm being configured to be supported on the receptacle when a force acts on the first connection element.

As a result, the first connection element is able to transfer forces which are relatively large with respect to its order of magnitude. The at least one support arm may have a certain flexibility, with the result that the support arm can be pressed out of a starting position against the body of the receptacle in the event of loading of the device. As an alternative, the outer end of the support arm can already make contact with the body of the receptacle in the starting position.

In an implementation, the device also comprises an attachment, the first connection element being brought in contact with the attachment to fasten the first connection element to the first body, the attachment being connectable to the first body or formed integrally with the first body.

In an embodiment, the attachment comprises a loop, the loop engaging around the first connection element in order to fix it to the first body. The combination of the first connection element and the attachment in the form of a loop forms a space-saving solution for connecting the device to the first body.

In a further implementation, the loop engages around the first connection element at least around 180°. This allows a planar configuration of the link between the first body and the device. In addition, an optimum transfer of force between the loop and the first connection element is provided. Finally, the first connection element can be held securely in a loop engaging around at least 180°.

In an embodiment, the attachment forms a pocket for receiving the first connection element, the first connection element being held in the pocket. The pocket makes it possible to securely receive the first connection element. In particular, it is also possible to be able to compensate forces transversely to the movement direction of the device. Furthermore, the pocket can enclose the entire receptacle in addition to the first connection element, and in the process serve for securing the position of the receptacle on the first body and for protection against the external action of force, such as impacts caused by objects which are not part of the device, for example.

In an implementation, the attachment is manufactured from a textile, plastic and/or metal. A configuration made of textile makes it possible to integrate the attachment easily in bandages, orthoses, sporting equipment, and sports clothing, such as shoes, for example. The textile attachment may, in the form of a loop or pocket, hold the first connection element or the first connection element including the receptacle, and be fastened to the first body by adhesive bonding, sewing, riveting, welding etc. As an alternative, the textile attachment may also be integrated in the first body. The same applies analogously for attachments which comprise plastic and/or metal.

### BRIEF DESCRIPTION OF THE FIGURES

Embodiments of the disclosure will be elucidated in more detail by the following description of the figures, in which:

FIG. 1A schematically shows a perspective view of a device,

FIG. 1B schematically shows a sectional view of the device from FIG. 1A,

FIGS. 1C, 1D schematically show other configurations of the device from FIG. 1A,

FIG. 2A schematically shows a side view of a device,

FIG. 2B schematically shows a sectional view of the device from FIG. 2A,

FIG. 3A schematically shows a side view of a device,

FIG. 3B schematically shows a sectional view of the device from FIG. 3A,

FIG. 4 schematically shows the device from FIG. 3 with an attachment,

FIG. 5 schematically shows the device from FIG. 1A with an attachment,

FIG. 6A schematically shows a side view of a device in a pocket, and

FIG. 6B schematically shows a plan view of the device from FIG. 6A.

### DETAILED DESCRIPTION

In the following text, exemplary embodiments will be described with reference to the figures. In the figures, elements which are the same, similar or have the same effect are provided with identical reference signs in the different figures, and a repeated description of these elements is in part omitted to avoid redundancies.

Various embodiments now will be described more fully hereinafter with reference to the accompanying drawings, which form a part hereof, and which show, by way of illustration, specific embodiments by which the innovations described herein can be practiced. The embodiments can, however, be embodied in many different forms and should not be construed as limited to the embodiments set forth herein; rather, these embodiments are provided so that this disclosure will be thorough and complete, and will fully convey the scope of the embodiments to those skilled in the art. The following detailed description is, therefore, not to be taken in a limiting sense.

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

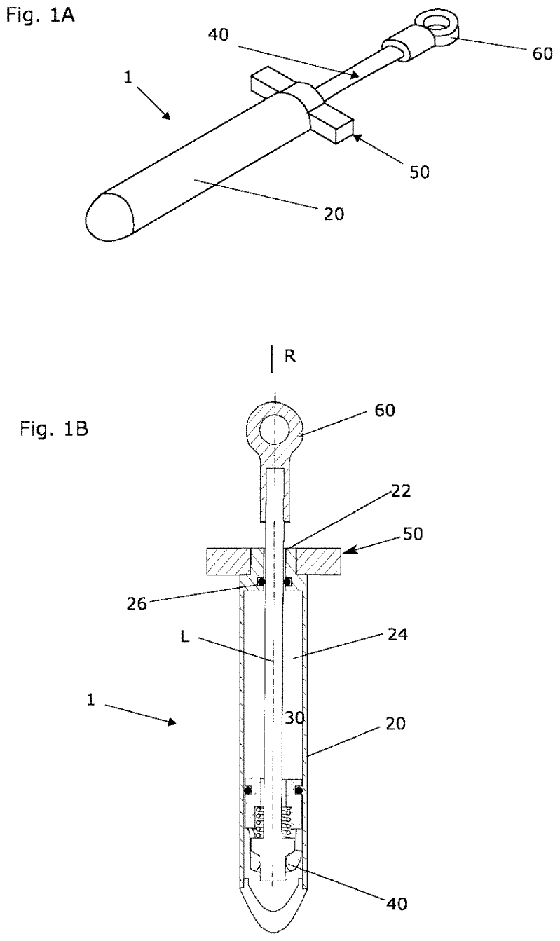

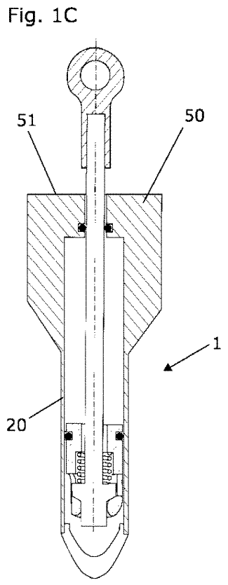

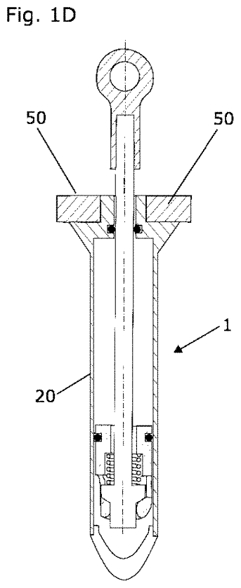

FIGS. 1A and 1B schematically show a device 1 for stabilizing movements of two bodies of a body joint and/or of an item of sporting equipment that can be moved relative to one another. The device 1 comprises a receptacle 20, which is filled with a filling medium 30. An interaction body 40 extends at least partially into a receiving space 24 of the receptacle 20. The device may be arranged between two bodies which can be moved relative to one another in such a way that the receptacle 20 is connected to a first body and the interaction body 40 is connected to a second body, with the result that a force flow can be defined between the two bodies which can be moved relative to one another by way of the device 1.

In the event of loading, i.e. when a force acts on the device starting from two bodies to be stabilized which are not part of the device, the interaction body 40 and the receptacle 20 can be moved relative to one another in a relative movement direction R.

The receptacle 20 has a receiving opening 22, through which the receptacle 20 can be filled with the filling medium 30. In addition, the interaction body 40 extends at least partially through the receiving opening 22, with the result that part of the interaction body 40 can always be located in the receiving space 24 and another part of the interaction body 40 can always be located outside the receptacle 20.

In the region of the receiving opening 22, the device 1 has a first connection element 50 for connection to a body which is not part of the device. The first connection element 50 extends perpendicularly to a longitudinal axis L of the device 1. As can be seen in FIGS. 1A and 1B, the first connection element 50 extends symmetrically from the longitudinal axis L of the device 1 and forms two connection projections or connection surfaces.

The first connection element 50 serves as an interface for the transfer of force between a first body which is not part of the device and the device 1. Arranged on the exposed part of the interaction body 40 is a second connection element 60 that serves as an interface for the transfer of force between a second body which is not part of the device and the device 1. Consequently, a force path is produced between the first connection element 50, the operative medium 30, the interaction body 40 and the second connection element 60 in the event of loading.

The arrangement of the first connection element 50 in the region of the receiving opening 22 makes it possible for the outer walls of the receptacle 20 to be largely relieved of load. For the unipartite configuration of connection element 50 and receptacle 20 shown in FIGS. 1A and 1B, this means that the receptacle 20 can have a comparatively thin-walled design, since a force flow through the device 1 is not directly tangent to the receptacle 20 in the event of loading.

In another embodiment, in which the first connection element and the receptacle are designed in two parts, the arrangement of the first connection element in the region of the receiving opening provides the advantage that an external force cannot have an adverse effect on the link between the first connection element and the receptacle.

As shown in FIG. 1B, the first connection element 50 defines the receiving opening 22. In order to ensure that the operative medium 30 can be held in the receiving space 24 in a usage situation, the receptacle 20 has an O-ring 26 in the region of the receiving opening 22.

The filling medium 30 is a Newtonian fluid, such as silicone oil. As an alternative, dilatant fluids may also be used. In addition, the filling medium may also be provided in the form of a shear-thickening plastic in powder form. Furthermore, filling materials such as sand, for example, may also be used.

FIGS. 1C and 1D show further configurations of the device 1, which differ from the device shown in FIGS. 1A and 1B in terms of the design of the first connection element. The device 1 according to FIG. 1C has a first connection element 50, which is formed integrally with the receptacle 20 and comprises a cylindrical portion which provides a comparatively large connection surface 51.

The device 1 according to FIG. 1D exhibits an annular connection element 50 that is adhesively bonded to the receptacle 20 and provides a comparatively large connection surface 51.

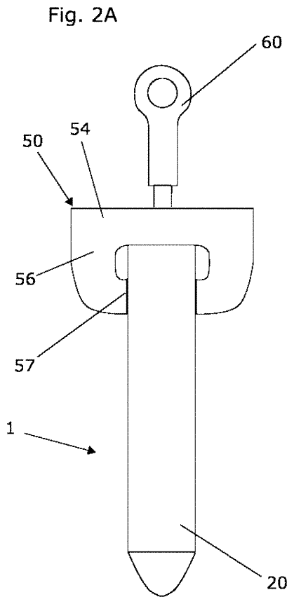

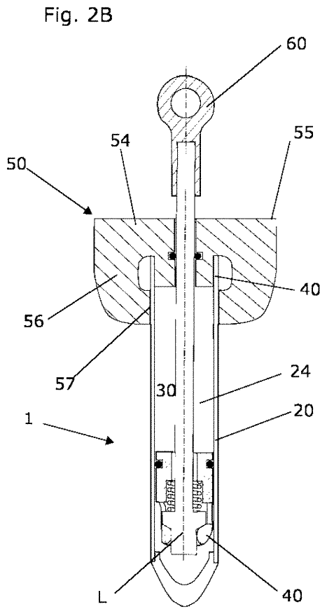

FIG. 2A schematically shows a side view of a further embodiment of the device 1. FIG. 2B shows a sectional view of the device 1 from FIG. 2A. FIGS. 2A and 2B show a first connection element 50 that has a geometry which is changed with respect to the first connection element according to FIGS. 1A and 1B.

According to FIGS. 2A and 2B, the first connection element 50 has two connection portions 54, which extend in a symmetrical manner perpendicularly from the longitudinal axis L of the device 1. Support arms 56 extend from an outer end 55 of the connection portions 54 substantially parallel to the longitudinal axis L of the device 1 along the receptacle 20. The ends of the support arms 56 each define a second outer end 57, which is configured to be supported on the receptacle 20 when a force acts on the first connection element 50. As a result of it being possible for the first connection element 50 to be supported on the receptacle 20 via the support arms 56, the first connection element 50 according to FIGS. 2A and 2B is able to transfer larger forces than the device shown in FIGS. 1A and 1B for this purpose.

In order to provide the supporting function, the first connection element 50 and in particular the support arms 56 have a flexible form. In a preferred material pairing, the receptacle 20 is manufactured from aluminum and the first connection element 50 is manufactured from plastic.

According to FIGS. 2A and 2B, the first connection element 50 and the receptacle 20 are designed in two parts. This provides the advantage that an external force cannot have an adverse effect on the link between the first connection element 50 and the receptacle 20. Forces starting from the interaction body 40 act on the filling medium 30 in the event of loading, said filling medium transferring the force in turn to the first connection element 50, which is arranged in the receiving opening 22. The force can then be transferred from the first connection element 50 to a body which is not part of the device.

In this respect, the force acting between the body which is not part of the device and the first connection element 50 ensures that the first connection element 50 is pressed into the receiving opening 22.

The first connection element 50 may be connected to the receptacle 20 in an adhesively bonded, welded, interference-fitting and/or form-fitting manner.

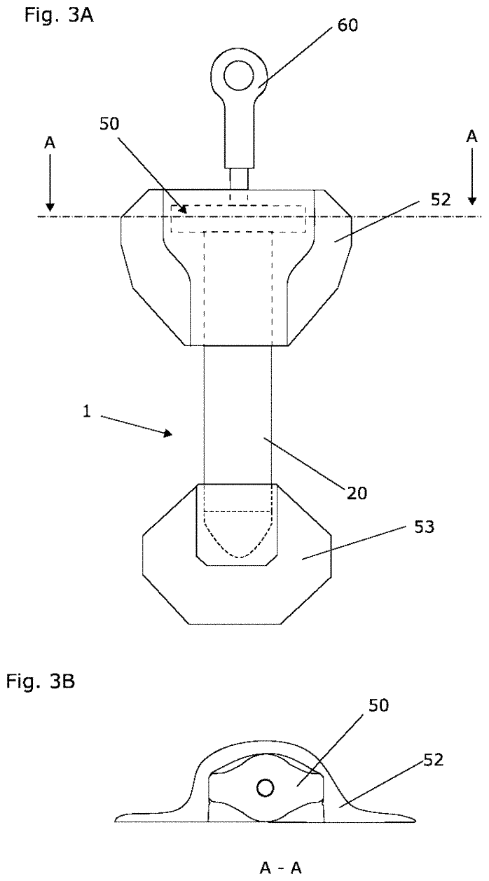

FIG. 3A shows a side view of a device 1 which comprises a first connection element 50 having two wing bodies 52, which extend perpendicularly from a longitudinal axis L of the device 1 and lie in a plane defined by the longitudinal axis L. The wing bodies 52 serve to increase the connection surface area for connection to a body which is not part of the device. The wing bodies 52 increase the surface area of the first connection element 50 and provide an additional surface as a result, which can be adhesively bonded or enclosed in a bandage in order to fasten the first connection element 50 to a first body which is not part of the device.

The first connection element 50 may be formed in one piece with the wing bodies 52. As an alternative, the first connection element 50 and the wing bodies 52 may also be designed separately. For example, the first connection element 50 may be provided, as shown in FIGS. 1A and 1B. A wing body has a negative imprint of the first connection element and part of the receptacle and may be connected to the first connection element in a form-fitting manner, for example by way of a clip link. As an alternative, the first connection element and the wing bodies may be adhesively bonded, welded or interference fitted.

FIG. 3A shows an additional wing body 53, which is arranged on an end portion of the receptacle 20. The wing body 53 makes it possible to provide an additional connection surface for the receptacle 20 to a body which is not part of the device. The connection surfaces of the wing bodies 52 and 53 are suitable for integration in textiles or for fastening to a body which is not part of the device with bandages, tapes, etc. In this respect, the connection surfaces of the wing bodies 52 and 53 may be adhesively bonded, welded, riveted, sewed etc. to a textile element.

FIG. 3B shows the section A-A from FIG. 3A. The wing body 52 is clipped on the connection body 50 by means of an interference fit. Apart from an interference fit, the wing body and the connection body may also be adhesively bonded, welded etc. As an alternative, the wing body and the connection body may also have a unipartite design.

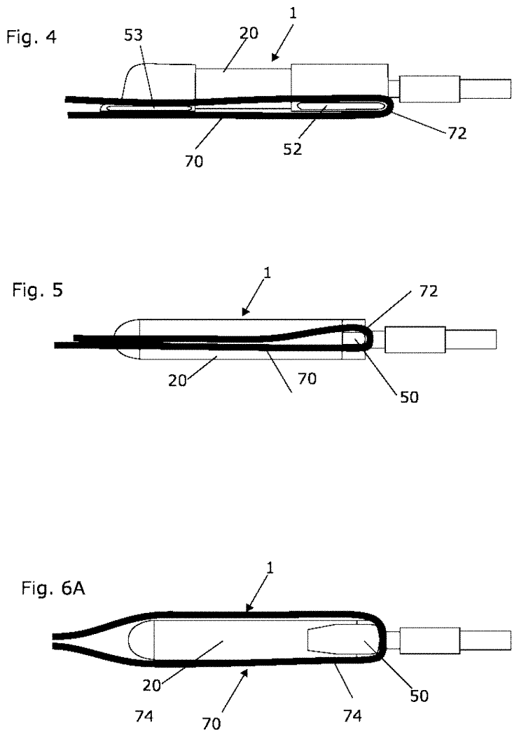

FIG. 4 shows a side view of the device 1 from FIG. 3, the wing bodies 52, 53 being enclosed by an attachment 70. In this respect, the attachment 70 forms a loop 72, which serves as an interface for the transfer of force between the first connection element 50 and the attachment 70. In addition to the transfer of force between the device 1 and a first body, the attachment 70 serves to keep the receptacle 20 in position by means of the wing bodies 52, 53. Consequently, the receptacle 20 may be held in abutment against a first body, for example.

FIG. 5 shows a side view of the device 1 from FIG. 1A, the first connection element 50 being enclosed by the attachment 70. In this respect, the attachment 70 forms a loop 72, which acts as an interface for the transfer of force between the first connection element 50 and the attachment 70.

The attachment shown in FIGS. 4 and 5 may be designed in the form of a textile loop or pocket, by means of which the first connection element or the first connection element including the receptacle 20 can be held and fastened to a first body by adhesive bonding, sewing, riveting, welding etc.

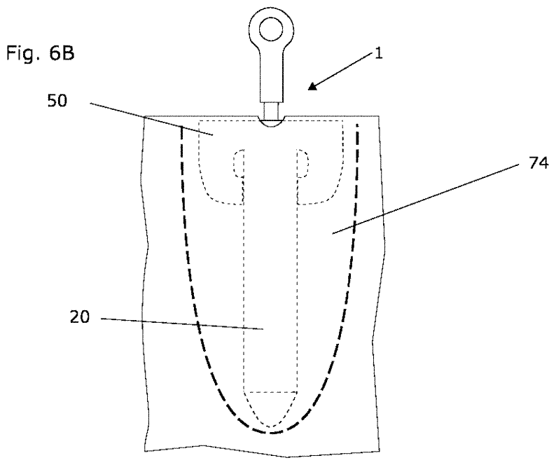

FIG. 6A shows a side view of a device 1 according to FIG. 2A, the device being arranged in an attachment 70 in the form of a pocket 74. FIG. 6B shows a plan view of the device according to FIG. 6A. The partial arrangement of the device 1 in the pocket 74 is illustrated by dashed lines. The pocket 74 is formed from a textile and accommodates the first connection element 50 and the receptacle 20. The pocket 74 may be fastened to the first body which is not part of the device by adhesive bonding, sewing, riveting, welding etc. As an alternative, the pocket 74 may also be integrated in the first body which is not part of the device.

If applicable, all individual features illustrated in the exemplary embodiments may be combined with one another and/or interchanged with one another without departing from the scope of the disclosure.

### LIST OF REFERENCE SIGNS

1 Device

20 Receptacle

22 Receiving opening

24 Receiving space

26 O-ring

30 Filling medium

40 Interaction body

50 First connection element

51 Connection surface

52 Wing body

54 Connection portion

55 First outer end

56 Support arm

57 Second outer end

60 Second connection element

70 Textile element

72 Loop

74 Pocket

L Longitudinal axis

R Relative movement direction

1. A device for stabilizing movements of two bodies of a body joint and/or of an item of sports equipment that can be moved relative to one another, said device comprising: a receptacle which can be fixed to a first body, the receptacle being filled with a filling medium, and
wherein the receptacle comprises a receiving opening
an interaction body which can be fixed to a second body, is displacably received at least partially in the receptacle and extends through the receiving opening
wherein the part of the interaction body which is located in the receptacle can interact with the filling medium
wherein the receptacle comprises a first connection element for the transfer of force between the receptacle and the first body, and
wherein the interaction body comprises a second connection element for the transfer of force between the interaction body and the second body,
the first connection element comprising at least one projection, which extends from a longitudinal axis of the device in order to provide a connection surface for fixing to the first body.

2. The device as claimed in 1, wherein the first connection element is arranged in the region of the receiving opening for the transfer of force between the receptacle and the first body.

3. The device as claimed in claim 2, wherein the first connection element is
inserted in the receiving opening or placed on the receiving opening and at least partially closes off a receiving space with respect to the surroundings.

4. The device as claimed in claim 2, wherein the first connection element at least partially closes off a receiving space of the receptacle with respect to the surroundings.

5. The device as claimed in claim 1, wherein the first connection element extends substantially perpendicularly from a relative movement direction (R) of the device in order to provide a connection surface for fixing to the first body.

6. The device as claimed claim 1, wherein the first connection element is configured to transfer forces of at least 300 N, preferably at least 1000 N, and particularly preferably at least 2000 N, between the receptacle and the first body.

7. The device as claimed claim 1, wherein the first connection element is formed in one piece with the receptacle.

8. The device as claimed in claim 1, wherein the first connection element is connected to the receptacle in an adhesively bonded, welded, screwed, interference-fitting and/or form-fitting manner.

9. The device as claimed in claim 1, wherein the first connection element comprises at least one wing body, which extends substantially perpendicularly from a relative movement direction of the device in order to form a planar connection for tapes, dressings, bandages, and the like.

10. The device as claimed in claim 1, wherein the first connection element comprises a connection portion, which extends substantially perpendicularly from a longitudinal axis of the device, and comprises at least one support arm on at least one outer end of the connection portion, wherein the support arm extends in part parallel to the receptacle, and wherein an outer end of the support arm is configured to be supported on the receptacle when a force acts on the first connection element.

11. The device as claimed in claim 1, wherein the device also comprises an attachment, the first connection element being brought in contact with the attachment to fasten the first connection element to the first body, wherein the attachment is connectable to the first body or formed integrally with the first body.

12. The device as claimed in claim 11, wherein the attachment comprises a loop, wherein the loop engages around the first connection element in order to fix it to the first body.

13. The device as claimed in claim 12, wherein the loop engages around the first connection element at least around 180°.

14. The device as claimed in claim 11, wherein the attachment is a pocket for receiving the first connection element, wherein the first connection element is held in the pocket.

15. The device as claimed in claim 11, wherein the attachment is manufactured from a textile, plastic and/or metal.

16. The device as claimed in claim 12, wherein the attachment is a pocket for receiving the first connection element, wherein the first connection element is held in the pocket.

17. The device as claimed in claim 13, wherein the attachment is a pocket for receiving the first connection element, wherein the first connection element is held in the pocket.

18. The device as claimed in claim 3, wherein the first connection element at least partially closes off the receiving space of the receptacle with respect to the surroundings

19. The device as claimed in claim 5, wherein the first connection element comprises at least one wing body, which extends substantially perpendicularly from a relative movement direction (R) of the device in order to form a planar connection for tapes, dressings, bandages, and the like.

20. The device as claimed in claim 5, wherein the device also comprises an attachment, the first connection element being brought in contact with the attachment to fasten the first connection element to the first body, wherein the attachment is connectable to the first body or formed integrally with the first body.
